(19) United States
(12) Patent Application Publication
(10) Pub. No.: US 2016/0238752 A1
(43) Pub. Date: Aug. 18, 2016

(54) VEHICLE MIRROR, AND METHOD FOR MANUFACTURING SUCH A MIRROR

(71) Applicant: AVIATION GLASS & TECHNOLOGY B.V., Voorthuizen (NL)

(72) Inventor: Jacob WIERSEMA, Voorthuizen (NL)

(73) Assignee: AVIATION GLASS & TECHNOLOGY B.V., Voorthuizen (NL)

(21) Appl. No.: 15/137,970

(22) Filed: Apr. 25, 2016

Related U.S. Application Data
(63) Continuation of application No. 14/783,518, filed on Oct. 9, 2015.

(30) Foreign Application Priority Data
Apr. 11, 2013 (NL) 2010625

(51) Int. Cl. G02B 5/08; G02B 1/14; G02F 1/153

(52) U.S. Cl. CPC G02B 5/0808; G02F 1/153; G02B 1/14

(57) ABSTRACT

The invention relates to a mirror. The invention further relates to a motor vehicle having one or more mirrors according to the invention. The invention also relates to an aircraft having a mirror according to the invention. In addition, the invention relates to a vessel having a mirror according to the invention. The invention also relates to a method for manufacturing a mirror according to the invention.

This application is a Continuation application of prior application Ser. No. 14/783,518, filed Oct. 9, 2015, which is a 371 National Stage application of International (PCT) Application No. PCT/NL2014/050230, filed Apr. 11, 2014. The contents of Ser. No. 14/783,518 are incorporated herein by reference in their entirety.

This application claims priority to NL 2010625, filed Apr. 11, 2013; and International Patent Application No. PCT/NL2014/050230, filed Apr. 11, 2014, the entire contents of which are hereby incorporated by reference.

The invention relates to a vehicle mirror. The invention further relates to a motor vehicle comprising a mirror according to the invention. The invention also relates to an aircraft comprising a mirror according to the invention. In addition, the invention relates to a vessel comprising a mirror according to the invention. The invention also relates to a method for manufacturing a vehicle mirror according to the invention.

### FIELD

Mirrors referred to in the present description generally comprise a glass sheet with a reflective metal layer deposited on the glass surface and a protective layer applied to the reflective metal. Examples of usually applied reflective metals are silver, chromium and copper. The protective layer, which is usually a paint layer, serves partially to protect the reflective metal from wear, but more particularly provides metal with resistance to corrosion. If the reflective metal is not given such an anti-corrosion protection, the metal then tends to undergo oxidation or be adversely affected by atmospheric contaminants, this resulting in the mirror becoming tarnished and discoloured, and therefore in a reduction of the specular, reflective properties of the mirror. Water, salts and/or other contaminants can moreover get in between the glass sheet and the reflective metal layer, which results in distortion and/or reduction of the reflection. Mirrors generally have a planar geometry and are used daily as cosmetic mirror and/or as safety mirror. In the case of a flat mirror the image generated by the mirror is the same size as the original. A significant drawback of the known mirrors is that they have a relatively low impact resistance and therefore break relatively easily. A further drawback of the known mirrors is that they are generally relatively heavy. The above stated drawbacks make the mirrors less suitable for application in vehicles, since this increases the weight of the vehicles and thereby the energy consumption, and moreover results in undesired splintering inside the vehicle if the mirror were to break.

### BACKGROUND

A first object of the invention is to provide an improved mirror with which at least one of the above stated drawbacks can be obviated.

### SUMMARY

A second object of the invention is to provide a mirror with a reduced weight.

A third object of the invention is to provide a mirror which has an increased impact resistance.

At least one of the above stated objectives can be achieved by providing a mirror of the type stated in the preamble, comprising: at least one ultra-thin, hardened first glass sheet with a maximum thickness of 1.0 mm, in particular a maximum thickness of 0.7 mm; at least one fastening layer connected directly or indirectly (via one or more (intermediate) layers) to a front side of the first glass sheet and comprising at least one polymer and at least one fire-retardant polymer, at least one strengthening plate connected directly or indirectly to the fastening layer, and at least one mirror layer arranged between the glass sheet and the strengthening plate. Because the mirror according to the invention comprises a laminate of mutually adhered material layers, a substantial increase in impact resistance can be realized, whereby in the case of an impact on the first ultra-thin glass sheet—generally the front side (foremost layer) of the mirror—splintering (decomposition) of the relevant hardened, ultra-thin glass sheet and the laminate can be prevented, this being particularly advantageous from a safety viewpoint. This impact resistance can be further increased in that the glass sheet is ultra-thin, with a thickness of less than or equal to 0.7 mm, and is subjected to a hardening process for the purpose of strengthening the glass structure. Application of the ultra-thin glass sheet will moreover enable a considerable reduction in the weight of the mirror, this being advantageous from a financial viewpoint and moreover being advantageous from an energy viewpoint when the mirror according to the invention is applied in a vehicle. The mirror according to the invention will generally have a planar geometry. It is however possible to envisage the mirror having a single or multiple curve geometry. The advantageous construction of the mirror according to the invention makes it possible to use the mirror in numerous applications and sectors, particularly in the construction industry and transport sector, in particular in transport vehicles, such as in automobiles, vessels and aircraft (aeroplanes). Within the context of this patent specification a mirror is understood to mean particularly, though not exclusively, a mirror intended for personal use. This means that a person can look in the mirror and will see an image. This image can be an image of themselves, whereby the mirror is particularly suitable as cosmetic mirror and/or safety mirror. If the person sees an image other than an image of him/herself, the mirror will be particularly suitable for application as safety mirror. The thickness of the glass sheet is preferably less than 1.0 mm, more preferably less than 0.7 mm, and can have a typical thickness of 0.3; 0.4; or 0.55 mm. The strengthening plate is formed by at least one, preferably chemically, hardened second glass sheet with a maximum thickness of 1.0 mm, more preferably a maximum thickness of 0.7 mm, which second glass sheet is positioned on a front side, remote from the first glass sheet, of the fastening layer connected to the first glass sheet. A part of the fastening layer left uncovered by the first glass sheet can be protected in fire-resistant and moisture-proof manner by applying an ultra-thin second glass sheet. The fastening layer in fact functions here as intermediate layer. It is possible here to envisage the second glass sheet being directly connected to a front side, remote from the first glass sheet, of the fastening layer connected to the first glass sheet. It is also possible to envisage the second glass sheet being indirectly connected to the fastening layer, i.e. without interposing of one or more intermediate material layers. If the glass laminate were to consist only of the first glass sheet, the fastening layer and the second glass sheet stacked in the manner of a sandwich and connected, the at least one end surface (peripheral side) of the fastening layer would be uncovered, this generally being undesirable from a fire safety viewpoint since the ionomer fastening layer is easily flammable and can moreover absorb moisture. It is therefore possible to envisage at least a substantial part and even substantially the whole of this end surface also being protected in the glass laminate according to the invention. Protection of the end surface of the fastening layer can for instance take place by means of the first glass sheet and/or the second glass sheet. In a particular preferred embodiment the second glass sheet is connected to the first glass sheet such that the fastening layer is substantially wholly enclosed by the second glass sheet and the first glass sheet. The first glass sheet and the second glass sheet are adhered or fused to each other here, so enclosing and confining the intermediate fastening layer.

Several advantageous embodiments of the mirror according to the invention will be described hereinbelow by way of illustration. Use is made in some embodiments of several inventive concepts. It is possible to envisage individual inventive concepts and technical measures being applied without all details of a determined embodiment also being applied therein.

It will be apparent that diverse modifications to the embodiments described below can be envisaged by a skilled person, wherein a skilled person can combine different inventive concepts and/or technical measures of different embodiments without departing from the invention described in the appended claims.

The first glass sheet and the second glass sheet are hardened in order to make the glass particularly strong. What particularly takes place here is a surface hardening, which results in a compressive stress at the outer surface of the glass sheet and a tensile stress in the core of the glass sheet. Hardening of the glass can take place in both chemical and thermal manner. Chemical hardening is generally recommended, wherein the (unhardened) glass is preferably immersed in a bath of molten potassium nitrate at a temperature of about 400° C. This results in chemical exchange of K⁺ ions from the bath with the Na⁺ ions from the glass. The K⁺ ions (size 2.66 Å) take the place of the Na⁺ ions (size 1.96 Å). Since they have larger dimensions they induce compressive stresses at the surface of the glass, which can thus provide more resistance. The duration of immersion determines the finally obtained stress level. The stress distribution does not take the same form as in the case of thermally hardened glass and generally results in considerably stronger glass than if unhardened glass were to be hardened in thermal manner. It is noted in this respect that chemically hardened glass generally has a much higher compressive stress at the surface of the glass sheet which decreases relatively quickly just beneath the surface, wherein there is a limited tensile stress in the centre (half depth) of the glass sheet, resulting in a block-shaped stress profile. Thermally hardened glass generally has a considerably lower compressive stress at the surface of the glass sheet, wherein a relatively high tensile stress is present in the centre of the glass sheet, resulting in a parabolic stress profile.

The most flammable component of the mirror according to the invention is generally formed by the fastening layer comprising the at least one polymer. In order to reduce the flammability of the fastening layer, which is advantageous from a safety viewpoint, it is recommended that the fastening layer comprises at least one fire-retardant additive. This additive prevents or at least counters the spread of fire. The additive is preferably formed by an organohalogen compound. Such compounds are able to remove reactive H and OH radicals during a fire. The organohalogen compound preferably comprises bromine and/or chlorine. Recommended from a viewpoint of fire retardance over an organochlorine compound such as PCB (polychlorinated biphenyl) is an organobromine compound such as PBDE (polybrominated diphenyl ether). Other examples of applicable brominated compounds are: Tetrabromobisphenol A, Decabromodiphenyl ether (Deca), Octabromodiphenyl ether, Tetrabromodiphenyl ether, Hexabromocyclododecane (HBCD), Tribromophenol, Bis(tribromophenoxy)ethane, Tetrabromobisphenol A polycarbonate oligomer (TBBA or TBBPA), Tetrabromobisphenol A epoxy oligomer (TBBA or TBBPA), and Tetrabromophthalic acid anhydride. Other examples of applicable chlorinated compounds are: Chlorinated paraffin, Bis(hexachlorocyclopentadieno)cyclooctane, Dodecachloride pentacyclodecane (Dechlorane), and 1,2,3,4,7,8,9,10,13,13,14,14-dodecachloro-1,4,4a,5,6,6a,7,10,10a,11,12,12a-dodecahydro-1,4,7,10-dimethanodibenzo[a,e]cyclooctene (Dechlorane Plus). Although halogenated flame retardants are particularly effective, they generally have the drawback that toxic smoke can result in the case of fire. It is therefore also possible to envisage applying one or more alternative, less toxic fire-retardant additives, including intumescent (foaming) substances. The operating principle of these alternative additives is based on formation of a foam layer which functions as oxygen barrier and therefore also has a fire-retardant effect. Such intumescent additives generally comprise melamine or a salt derived therefrom. An example hereof is a mixture of polyphosphates (acid donor) in co-action with a melamine (foaming agent) and a carbon donor such as dipentaerythritol, starch or pentaerythritol. Gaseous products such as carbon dioxide and ammonia gas are formed here in the case of fire. The formed foam layer is stabilized by cross-linking, as in the case of vulcanization. Other examples of applicable, relatively environmentally-friendly, melamine-based additives are: melamine cyanurate, melamine polyphosphate and melamine phosphate. In addition to the above stated additives the fastening layer can also be provided with one or more fire-retardant additives configured to prevent pyrolysis, produce (oxygen-displacing) nitrogen gas and/or produce (cooling) water in the case of fire. An example of this latter category are metal hydroxides which are converted during fire to metal oxide and water molecules, wherein the water molecules ensure that the oxygen concentration around the burning material is reduced and the fire intensity thus decreases. This reaction is moreover endothermic, so that heat is also extracted from the fire, this producing a cooling effect, whereby the fire is also retarded. An example here of a suitable metal hydroxide is aluminium hydroxide (ATH).

In a preferred embodiment the fastening layer comprises at least one fibre-reinforced polymer and/or another reinforced material. The at least one polymer can for instance be provided here with and be strengthened with glass fibres and/or carbon fibres. This results in a considerable increase in the strength of the mirror according to the invention. This fibre-reinforced intermediate layer (fastening layer) moreover results in an improved retention of glass splinters in the first glass sheet in the case of breakage, which is particularly advantageous from a safety viewpoint. The fibres can be incorporated as separate (individual) fibres in the polymer, in particular a resin, such as for instance an epoxy resin, a polyester resin and/or a phenol resin. It is however also possible to envisage the reverse being the case, thereby resulting in a so-called prepreg. Use is made in a prepreg of a fibre layer functioning as substrate (carrier), particularly a fibre web (woven), a fibre lattice (two-dimensional), a fibre matrix (two-dimensional or three-dimensional) and/or other (non-woven) substrate, impregnated beforehand or otherwise provided with one or more thermosetting polymers, this resulting in a thin layer, in particular a film and/or tape, manufactured from fibre-reinforced polymer. As substrate use can for instance be made here of a (flexible) web of for instance glass fibre, carbon fibre or aramid fibre (Kevlar), wherein this web is impregnated with a (synthetic) resin such as an epoxy resin, a polyester resin and/or a phenol resin. Resins on the basis of benzoxazine and/or cyanate esters can optionally also be applied. Such prepregs are supplied as semi-manufactures, wherein the applied resins or other types of thermosetting polymer have initially not yet (fully) cured, whereby the polymers, and thereby the prepreg, retain a desired flexibility and tackiness, which considerably simplifies the subsequent lamination of the prepreg with the other layers of the mirror according to the invention. In order to ensure this flexibility of the prepregs as far as possible the prepregs are preferably stored at relatively low temperatures, such as for instance a temperature of −20° C. During the actual laminating process for manufacturing the mirror according to the invention a pressure differing from atmospheric pressure (overpressure or underpressure) will be exerted, for instance by means of vacuum bags (for the purpose of realizing an underpressure) or an autoclave (for the purpose of realizing an overpressure). The laminate will also be heated here to a temperature (considerably) above room temperature, whereby on the one hand adhesion of the at least one thermosetting polymer to adjacent layers will take place and on the other curing or cross-linking of the at least one thermosetting polymer will take place, whereby strength is imparted to the construction of the formed mirror. This curing of the thermosetting polymer, wherein a polymer network is formed, is irreversible, whereby the formed mirror also retains a desired strength at increased temperature. In an alternative embodiment variant of the method for manufacturing the mirror according to the invention it is possible to envisage the fibre-reinforced thermocuring fastening layer being cured in advance, so before lamination, whereby a fibre-reinforced polymer sheet or layer is formed which can subsequently be connected, for instance by means of a separate glue layer (fastening layer or adhesive layer), to one or more adjacent layers, thus forming the mirror according to the invention. By strengthening (reinforcing) the fastening layer, preferably by means of fibres, it is possible that an additional strengthening plate, formed particularly by the second glass sheet, need no longer be applied, which can result in a favourable weight-saving. In this embodiment variant the adhesive functionality of the fastening layer and strengthening functionality of the strengthening plate are thus combined in a single layer, a strengthened fastening layer. In this context the second glass sheet could be considered optional and could be dispensed with.

The mirror layer is preferably arranged between the first glass plate and the fastening layer. The reflective (specular) capacity of the mirror layer is in this way minimally affected, while the mirror layer is nonetheless protected (screened) by the first glass sheet. The mirror layer can take diverse forms. It is possible here to envisage the mirror layer being embodied as a film reflective on at least one side. An advantage of a film is that the layer thickness of the mirror layer is substantially homogenous, which will enhance homogenous reflection of the mirror. It is also possible to envisage a (thin) metal (oxide) layer being arranged on another layer of the laminate, this other carrier layer preferably being formed by the first glass sheet. Examples of suitable metals are copper, silver, gold, nickel, aluminium, Beryllium, chrome, molybdenum, platinum, rhodium, tungsten and titanium. The metal layer can be arranged on the carrier layer, in particular the first glass sheet, by means of vacuum vapour deposition techniques and/or sputtering. The arranged metal layer can optionally be at least partially removed, for instance by means of sandblasting, in order to make a part of the mirror wholly or semi-transparent and/or to impart a satinized (matt) appearance to the mirror. This makes it possible to generate visual effects behind the mirror layer, for instance in a separate material layer, which will be visible via the semi-transparent mirror to persons looking in the mirror. The above stated examples of the mirror layer are embodiments wherein the (static) mirror layer takes a permanently specular form.

It is however also possible to envisage the mirror layer taking a semi-permanent (temporarily) specular form. The mirror layer can generally be made specular as desired here. This is possible for instance by having at least a part of the mirror layer formed by an electrochromic layer. Connecting the electrochromic layer, optionally on the basis of liquid crystals (LCD), to an electrical energy source such as a battery enables the layer to be charged, whereby the specular layer can be activated or deactivated. The electrochromic layer can optionally be co-laminated during the production process. Later assembly of such a layer with the already formed laminate can also be envisaged. It is possible to envisage positioning the thermochromic layer behind an optionally non-specular, optionally made non-specular, part of the mirror, particularly of the first glass sheet.

The light transmission of the mirror layer depends on the type of mirror layer applied and the intended use of the mirror. This light transmission will generally lie between 10% and 80%. This means that the maximum reflectivity of the mirror layer will generally lie between 20% and 90%. The thickness of the mirror layer also depends on the type of mirror layer used, wherein the thickness of for instance a metal layer generally lies in the order of magnitude of 70-100 nanometres for an opaque mirror and can be even smaller in the case of (semi-)light-transmitting mirrors, while an electrochromic layer generally lies in the order of magnitude of micrometres up to several millimetres, typically between 10 micrometres and 2 millimetres. In a preferred embodiment a side of the mirror layer remote from the first glass sheet is at least partially provided with a coating which protects the mirror layer. The coating is particularly advantageous when the mirror layer is formed by a metal layer so that oxidation of the metal layer can be prevented or at least countered. If the mirror layer is formed by a copper layer, it is for instance possible to envisage covering the copper layer with an inhibitor on the basis of for instance azole derivative. Further details hereof are described in the British patent GB1074076. The use of azole-based inhibitors has resulted in a discernible improvement in preventing or retarding the appearance of a haze by preventing oxidation of the copper and consequently also of an optional underlying layer of silver. The coating can also be applied to the peripheral edge(s) of the mirror layer in order to also protect the end surface against corrosion.

The protective layer is preferably applied as paint with a residual internal stress SR which is equal to or less than 1 MPa, measured according to the cantilever method, at a temperature above its glass transition temperature, which can result in a greatly increased resistance to corrosion. The paint applied as protective layer for a metal layer arranged on the first glass sheet is generally deposited in liquid form and is baked or otherwise treated in order to evaporate the solvent and/or enhance cross-linking and therefore achieve curing of the paint. One of the most important characteristics the paint is preferably required to display is a strong adhesion to the metal layer. A relatively strong adhesion to the metal can be obtained due to the low residual stress. A further description of this embodiment is included in the Netherlands patent NL9000160, the content of which forms part of the description of this patent specification by way of reference.

The coating preferably has a temperature resistance of at least 130° C., more preferably at least 150° C. This makes it possible to keep the coating fully intact during lamination of the different material layers of the mirror. This laminating process generally takes place at about 130° C.

Because the protective coating is preferably applied directly to the mirror layer, the mirror layer and the coating are preferably arranged between the first glass sheet and the fastening layer. As already stated in the foregoing, this has the significant advantage that the reflective capacity of the mirror layer is not noticeably affected because only the ultra-thin (clear) first glass sheet is arranged in front of the mirror layer.

The most important objective of the fastening layer is to adhere the first glass sheet and the rear strengthening plate (second glass sheet) to each other directly or indirectly (via one or more intermediate layers) so that a relatively strong and stable laminate can be obtained, this generally enhancing the durability and the impact resistance of the laminate. In a possible embodiment the fastening layer is initially formed by a solid, liquid or pasty adhesive layer, such as for instance an epoxy adhesive or polyurethane adhesive. The fastening layer is preferably formed at least partially by a plastic film. This film will fuse with adjacent material layers during the laminating process. The film can for instance be manufactured from ethylene vinyl acetate (EVA). The advantage of EVA is that this polymer is particularly suitable for mixing with additives, whereby special properties can be imparted to the mirror. A drawback of EVA is that EVA is relatively soft and is less to be recommended from a structural viewpoint. The fastening layer can also be manufactured from polyvinyl butyral (PVB), which generally has a relatively limited thickness of about 0.38 mm and can be acquired relatively cheaply. The film can optionally take an adhesive form on one or two sides, which can simplify the manufacture of the laminate and/or the mutual alignment and stabilization of material layers.

The fastening layer is preferably manufactured at least partially from an ionomer. Ionomers are polymer materials with hydrophobic organic chains to which a small number of ionic groups is bonded. Ionomers are mainly synthesized by copolymerization of at least one functional monomer with at least one unsaturated monomer, after which some of the functional groups of the at least one functional monomer are neutralized by a metal cation, whereby highly polar salt groups are formed in the copolymer. These highly polar salt groups combine into small clusters which act as temporary, thermoreversible cross-links at room temperature but which soften sufficiently at increased temperature to enable thermoplastic processing. Due to the presence of the thermoreversible cross-links the elasticity of the ionomer will be considerably higher than the elasticity of the known prior art thermoplastics. Research into the mechanical properties and melt processability has moreover revealed that ionomers can have relatively good mechanical properties and a relatively high melt viscosity, depending on the composition of the ionomers, whereby a high impact resistance can be guaranteed and whereby the adhesive capacity of the fastening layer for adhesion to glass can be considerably improved.

The ionomer preferably comprises a copolymer of ethylene and a carboxylic acid chosen from the group consisting of: α,β-unsaturated carboxylic acids with 3-8 carbon atoms, wherein some of the acid groups are neutralized with at least one metal ion. It is particularly advantageous here for zinc ions to be used for neutralizing some of the acid groups of the at least one applied carboxylic acid. Research has shown that ionomers are to a certain extent of hydrophilic nature. However, the quantity of absorbed water is greatly dependent on the type of counter-ion. Compared to alkaline-earth or zinc ionomers, the alkali-neutralized ionomers absorb the most water. The zinc-based ionomers absorb the least water and are therefore generally recommended. An ionomer with an advantageous action is a semi-crystalline thermoplastic based on a random copolymer of ethylene and methacrylic acid which is partially neutralized to form a zinc or sodium salt.

An increase in the degree of neutralization of the ionomer results in an increase in the melt viscosity, tensile strength, hardness, impact resistance, and a decrease in the elongation at break and a decrease in the adhesive capacity of the ionomer. It is therefore important to find a balance in the degree of neutralization which on the one hand has to be sufficiently high to impart sufficient impact resistance and elasticity to the ionomer and which on the other is sufficiently low to guarantee a good adhesion and processability of the ionomer. This balance can be found when 15-45%, in particular 20-35%, of the acid groups are neutralized with at least one metal ion. A degree of neutralization greater than 45% makes the ionomer difficult to process, wherein it has moreover been found that the fastening layer can then be adhered less easily and less well to the glass sheet. This is because in the case of an ionomer the adhesion of the fastening layer to the glass sheet is determined mainly by the remaining acid groups in the copolymer. A degree of neutralization below 15% results in too few cross-links, this manifesting itself in a decreased elasticity, which is undesirable from a viewpoint of applicability. Particularly favourable properties are obtained when between about 20% and about 35% of the acid groups are neutralized.

The copolymer preferably comprises a percentage by weight of ethylene which lies within the range of 70-79% by weight. Too high a weight fraction of polyethylene (>79%) usually results in the structure of the fastening layer being too brittle and not elastic enough. The crystallinity of the fastening layer will moreover become too high here, which has an adverse effect on the light transmission of the fastening layer. Too low a weight fraction of polyethylene (<79%) usually results in a fastening layer which is too rubbery, and while this does enhance the elasticity it can make the processing of the fastening layer considerably more difficult.

The copolymer preferably comprises a percentage by weight of carboxylic acid which lies within the range of 21-30% by weight. The weight fraction (%) of the carboxylic acid generally amounts to 100% minus the weight fraction (%) of the polyethylene. It is however also possible to envisage one or more additives being added to the ionomer, thereby influencing the weight fraction of the carboxylic acid in particular. An example of such an additive are derivatives of methacrylic acid such as salts, esters and polymers of these derived monomers. Acrylic acid and methacrylic acid are generally most suitable as carboxylic acid when flexibility of the mirror is deemed of importance. As additives it is possible to envisage oil, such as paraffin oil (Sunpar 2280, Sunoco Holland B.V.) and/or fillers so as to enable manipulation of the mechanical properties.

It is surmised that the relatively high impact resistance of the mirror as such is obtained because, before it is neutralized, the copolymer has a melt index (MI) lower than 60 grams/10 min at 190° C., preferably lower than 55 grams/10 min, more preferably lower than 50 grams/10 min, particularly lower than 35 grams/10 min. Following neutralization of the copolymer with one or more cations, preferably zinc, the MI is preferably lower than 2.5 grams/10 min and possibly lower than 1.5 grams/10 min.

The fastening layer applied in the mirror according to the invention is preferably manufactured from a material with a Young's modulus (E-modulus) of at least 150 MPa, particularly at least 200 MPa, more particularly at least 250 MPa. The Young's modulus of the fastening layer more preferably lies between 250 and 350 MPa, particularly between 290 and 310 MPa. This relatively high modulus has the advantage that the material is relatively stiff and strong, this enhancing the impact resistance.

The fastening layer can optionally be formed by a thermoset. An example of a suitable thermoset is bakelite, a resin on the basis of phenol and formaldehyde (PF). Other examples are alkyd resins, epoxy resins (EP), polyurethane (PUR), melamine formaldehyde (MF), unsaturated polyesters (UP and GUP). Application of a thermoset can impart more strength to the laminate than if a thermoplastic such as EVA is used. Thermosets are however generally not transparent, whereby this application is advantageous only when transparency of the fastening layer in the mirror is of no importance.

It can be advantageous for the fastening layer to take a substantially transparent form. This can be particularly advantageous when the mirror layer takes a semi-transparent form, wherein visual effects are generated behind the fastening layer which are to be shown to persons looking in the mirror. It is otherwise possible to envisage the first glass sheet and/or the fastening layer being provided with a colorant in order to give the glass laminate a colour.

The thickness of the fastening layer preferably amounts to no more than 2.5 mm, more preferably no more than 1.8 mm. The fastening layer will generally be prefabricated here as film before being incorporated into the mirror according to the invention.

The strengthening plate, formed by the second glass sheet, gives the laminate of the mirror additional stiffness and strength, and makes an essential contribution toward increasing the impact resistance of the mirror as such. Behind the second glass sheet, so on a side of the second glass sheet remote from the first glass sheet, an additional strengthening plate can be arranged which can be made from a grid, such as a metal grid or a plastic grid, for instance provided with a honeycomb structure. A honeycomb structure is generally relatively light in weight, while such a structure is nevertheless relatively strong and sturdy.

It is generally advantageous for the laminate to comprise an adhesive layer for attaching the laminate to a bearing structure such as a wall. Using the adhesive layer the mirror can be attached relatively easily to a bearing structure such as for instance a wall, ceiling or piece of furniture. The adhesive layer will initially be covered by means of a cover film which will be removed just before the mirror is arranged on the bearing structure.

It is also possible to envisage the mirror comprising at least one additional material layer positioned on a front side of the fastening layer remote from the first glass sheet, wherein the at least one additional material layer is preferably chosen from the group consisting of: a decorative layer, a coloured layer, an additional fastening layer, an electronic layer, a light-reflecting layer and an additional glass sheet. It is usually advantageous here for the additional material layer to take an at least partially transparent form, whereby it is optionally possible to look through the mirror.

The thickness of the fastening layer preferably amounts to no more than 2.5 mm, more preferably no more than 1.8 mm. The fastening layer will generally be prefabricated here as film before being incorporated into the glass laminate according to the invention. Since the glass laminate is generally applied as glazing, it is advantageous for the fastening layer to be at least partially and preferably substantially wholly light-transmitting. It is otherwise possible to envisage the first glass sheet and/or the fastening layer being provided with a colorant in order to give the glass laminate a colour.

In order to make the peripheral side, also referred to as end surface or edge, of the at least one glass sheet less vulnerable, it is generally also advantageous for this peripheral side to be treated, in particular polished. Polishing of the peripheral sides can generally take place in chemical, thermal and/or mechanical manner. At least one separate protective element can optionally be used to protect the end surfaces of the at least one glass sheet, and optionally to protect the peripheral edge of the whole mirror.

The invention further relates to a vehicle comprising one or more mirrors according to the invention. The mirrors can serve additionally here as glazing, video screen, as touchscreen or combinations thereof. Vehicles are understood to mean, among others, motorbikes, automobiles, vessels and aircraft.

The invention also relates to a method for manufacturing a mirror for a vehicle, in particular a mirror as described in the foregoing, comprising the steps of: A) providing at least one ultra-thin, hardened first glass sheet with a maximum thickness of 1.0 mm, B) arranging a mirror layer on at least one front side of the first glass sheet, C) successively laying onto each other the first glass sheet provided with the mirror layer, a fastening layer comprising at least one polymer, and a hardened second glass sheet with a maximum thickness of 1.0 mm, preferably a maximum thickness of 0.7 mm, and D) laminating by means of heating the assembly formed during step C), thus forming the mirror. During heating of the laminate the intermediate polymer fastening layer will become soft and adhere to the material layer, particularly the first glass sheet and the second glass sheet, lying on either side of the fastening layer. Although the fastening layer is generally formed by a film, optionally a film which is adhesive on one or two sides, it is also possible to envisage the fastening layer being formed by an adhesive layer, such as an epoxy adhesive layer or a polyurethane adhesive layer. In this latter case the adhesive layer will be applied during step C) on the second glass sheet, after which the first glass sheet provided with the mirror layer is laid onto the adhesive, or vice versa. The fastening layer arranged during step C) preferably comprises at least one thermosetting polymer, this thermosetting polymer being at least partially and preferably substantially wholly cured during step D). A relatively sturdy construction of the mirror can in this way be obtained. The construction can be further reinforced by applying a fibre-reinforced thermosetting polymer. Use will usually be made here of a fibre-reinforced layer (substrate), in particular a fibre-reinforced web, on and in which the thermosetting material is arranged (impregnated).

Preferred embodiments of the invention are set forth in the clauses below:

1. Mirror, comprising:
at least one ultra-thin, hardened first glass sheet with a maximum thickness of 1.0 mm;
at least one fastening layer comprising at least one polymer and connected to a front side of the first glass sheet;
at least one strengthening plate optionally connected to the fastening layer, and
at least one mirror layer arranged between the glass sheet and the strengthening plate.
   2. Mirror according to clause 1, wherein the mirror layer is positioned and/or arranged between the first glass sheet and the fastening layer.
   3. Mirror according to clause 1 or 2, wherein at least a part of the mirror layer is formed by a film.
   4. Mirror according to any of the foregoing clauses, wherein at least a part of the mirror layer comprises at least one metal or metal oxide.
   5. Mirror according to any of the foregoing clauses, wherein at least a part of the mirror layer takes a satinized form.
   6. Mirror according to any of the foregoing clauses, wherein at least a part of the mirror layer is formed by an electrochromic layer.
   7. Mirror according to any of the foregoing clauses, wherein the mirror layer has a light transmission of between 10% and 80%.
   8. Mirror according to any of the foregoing clauses, wherein a side of the mirror layer remote from the first glass sheet is at least partially provided with a coating which protects the mirror layer.
   9. Mirror according to clause 8, wherein the coating is substantially impermeable to oxygen.
   10. Mirror according to clause 8 or 9, wherein the coating has a temperature resistance of at least 150° C.
   11. Mirror according to clause 2 and any of the clauses 8-10, wherein the mirror layer and the coating are arranged between the first glass sheet and the fastening layer.
   12. Mirror according to any of the foregoing clauses, wherein the first glass sheet is chemically hardened.
   13. Mirror according to any of the foregoing clauses, wherein the fastening layer is formed at least partially by a film.
   14. Mirror according to clause 13, wherein the fastening layer is manufactured at least partially from an ionomer.
   15. Mirror according to clause 14, wherein the ionomer comprises a copolymer of ethylene and a carboxylic acid chosen from the group consisting of α,β-unsaturated carboxylic acids with 3-8 carbon atoms, wherein some of the acid groups are neutralized with at least one metal ion.
   16. Mirror according to clause 15, wherein the at least one metal ion is formed by a zinc ion.
   17. Mirror according to clause 15 or 16, wherein 15-45%, in particular 20-35%, of the acid groups are neutralized with at least one metal ion.
   18. Mirror according to any of the clauses 15-17, wherein the carboxylic acid is formed by acrylic acid and/or methacrylic acid.
   19. Mirror according to any of the foregoing clauses, wherein the fastening layer has a melt index (MI) of about 60 g/10 min or less before neutralization, determined at a temperature of 190° C.
   20. Mirror according to any of the foregoing clauses, wherein the fastening layer is manufactured from a material with a Young's modulus of at least 150 MPa, particularly at least 200 MPa, more particularly at least 250 MPa.
   21. Mirror according to clause 20, wherein the Young's modulus of the fastening layer lies between 250 and 350 MPa, particularly between 290 and 310 MPa.
   22. Mirror according to any of the foregoing clauses, wherein the fastening layer is substantially transparent.
   23. Mirror according to any of the foregoing clauses, wherein the fastening layer has a thickness of a maximum of 2.5 mm.
   24. Mirror according to any of the foregoing clauses, wherein the mirror comprises at least one hardened second glass sheet with a maximum thickness of 0.7 mm, which second glass sheet is positioned on a front side, remote from the first glass sheet, of the fastening layer connected to the first glass sheet.
   25. Mirror according to clause 13, wherein the second glass sheet is directly connected to a front side, remote from the first glass sheet, of the fastening layer connected to the first glass sheet.
   26. Mirror according to clause 24 or 25, wherein the second glass sheet is connected to the first glass sheet such that the fastening layer is substantially wholly enclosed by the second glass sheet and the first glass sheet.
   27. Mirror according to any of the foregoing clauses, wherein the laminate comprises an adhesive layer for attaching the laminate to a bearing structure such as a wall.
   28. Mirror according to any of the foregoing clauses, wherein the laminate has a substantially planar geometry.
   29. Mirror according to any of the foregoing clauses, wherein the mirror comprises at least one additional material layer positioned on a front side of the fastening layer remote from the first glass sheet, wherein the at least one additional material layer is chosen from the group consisting of: a decorative layer, a coloured layer, an additional fastening layer, an electronic layer, a reflective layer and an additional glass sheet.
   30. Mirror according to clause 29, wherein the additional material layer is at least partially transparent.
   31. Mirror according to any of the foregoing clauses, wherein at least a part of an end surface of at least one glass sheet is polished.
   32. Mirror according to any of the foregoing clauses, wherein the fastening layer is formed by an adhesive layer.
   33. Mirror according to any of the foregoing clauses, wherein the fastening layer is formed by film which is adhesive on at least one side.
   34. Motor vehicle comprising a mirror according to any of the clauses 1-33.
   35. Aircraft comprising a mirror according to any of the clauses 1-33.
   36. Vessel comprising a mirror according to any of the clauses 1-33.
   37. Method for manufacturing a mirror, particularly according to any of the clauses 1-33, comprising the steps of:
   A) providing at least one ultra-thin hardened first glass sheet with a maximum thickness of 0.7 mm,
   B) arranging a mirror layer on at least one front side of the first glass sheet,
   C) successively laying onto each other the first glass sheet provided with the mirror layer, a fastening layer comprising at least one polymer, and a strengthening plate, and
   D) laminating by means of heating the assembly formed during step C), thus forming the mirror.

### BRIEF DESCRIPTION OF THE FIGURES

The invention will be elucidated on the basis of non-limitative exemplary embodiments shown in the following figures. Herein:

FIG. 1 shows a side view of a laminate according to a first embodiment of a mirror according to the invention,

FIG. 2 shows a side view of a laminate according to a second embodiment of a mirror according to the invention, and

FIG. 3 shows a perspective view of the application of a mirror according to the invention in a sanitary space of a vehicle.

### DETAILED DESCRIPTION

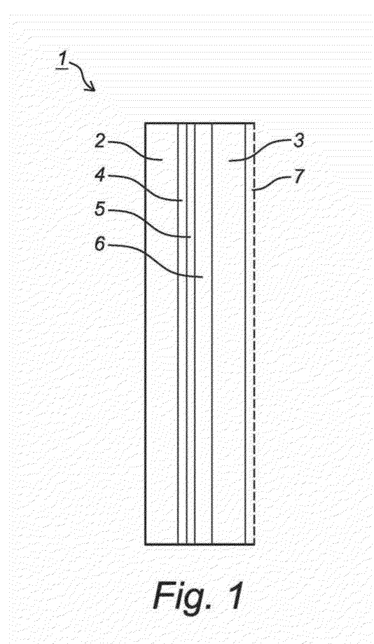

FIG. 1 shows a side view of a laminate according to a first embodiment of a mirror 1 according to the invention, particularly for use in or on vehicles, in particular aircraft (aeroplanes). Mirror 1 comprises in this exemplary embodiment a chemically hardened, ultra-thin glass sheet 2 with a thickness of a maximum of 0.7 mm, and a second ultra-thin, chemically hardened glass sheet 3 with a thickness of a maximum of 0.7 mm. The ultra-thin glass sheet 2 forms here a front side of mirror 1. A specular metal layer 4 is vapour-deposited onto the front glass sheet 2 by means of known techniques. Metal layer 4 is then protected by application of an (optional) protective coating 5 which particularly forms an oxygen barrier for preventing corrosion of metal layer 5. The front glass sheet 2 having thereon the reflective metal layer 4 and coating 5 on the one hand and the rear glass sheet 3 on the other are mutually connected by application of an ionomeric intermediate layer 6 (fastening layer). The thickness of intermediate layer 6 lies between 0.3 and 1.8 mm and in particular has a typical thickness of 0.89 mm in this exemplary embodiment. In the shown assembled situation the intermediate fastening layer 6 is fused with glass sheets 2, 3, or at least with coating 5 and with the rear glass sheet 3, thereby creating a strong yet flexible structure. The eventual shape of mirror 1 is determined by the shape of the ultra-thin glass sheets 2, 3. The ultra-thin glass sheets 2, 3 can have numerous and mutually differing compositions. Stated only by way of example is that glass sheets 2, 3 can be manufactured from: 64-68 mol. % Sift; 12-16 mol. % Na₂O; 8-12 mol. % Al₂O₃; 0-3 mol. % B₂O₃; 2-5 mol. % K₂0; 4-6 mol. % MgO; and 0-5 mol. % CaO, wherein: 66 mol. %≦SiO₂+B₂O₃+CaO≦69 mol. %; Na₂O+K₂0+B₂O₃+MgO+CaO+SrO>10 mol. %; 5 mol. %≦MgO+CaO+SrO≦8 mol. %; (Na₂O+B₂O₃)—Al₂O₃≦2 mol. %; 2 mol. %≦Na₂O—Al₂O₃≦6 mol. %; and 4 mol. %≦(Na₂O+K₂O)—Al₂O₃≦10 mol. %. A preferred embodiment of the composition of soda-lime glass to be used is shown in the following table:

| | Preferred percentage | Preferred range |
|---|---|---|
| | (Mol %) | (Mol %) |
| SiO₂ | 71.86 | 63-81 |
| Al₂O₃ | 0.08 | 0-2 |
| MgO | 5.64 | 0-6 |
| CaO | 9.23 | 7-14 |
| Li₂O | 0.00 | 0-2 |
| Na₂O | 13.13 | 9-15 |
| K₂O | 0.02 | 0-1.5 |
| Fe₂O₃ | 0.04 | 0-0.6 |
| Cr₂O₃ | 0.00 | 0-0.2 |
| MnO₂ | 0.00 | 0-0.2 |
| Co₃O₄ | 0.00 | 0-0.1 |
| TiO₂ | 0.01 | 0-0.8 |
| SO₃ | 0.00 | 0-0.2 |
| Se | 0.00 | 0-0.1 |

It is also possible to envisage using glass with the following composition:

| | Preferred range |
|---|---|
| | (Mol %) |
| SiO₂ | 61-75 |
| Al₂O₃ | 7-15 |
| MgO | 0-7 |
| CaO | 0-3 |
| Na₂O | 9-21 |
| K₂O | 0-4 |
| B₂O₃ | 9-21 |

The above stated composition can of course be modified, and components can be omitted and/or be added to the above stated composition.

The glass is chemically hardened in order to make the glass particularly strong. The (unhardened) glass is preferably immersed here in a bath of molten potassium nitrate at a temperature of about 400° C. This results in chemical exchange of K⁺ ions from the bath with the Na⁺ ions from the glass. The K⁺ ions (size 2.66 Å) take the place of the Na⁺ ions (size 1.96 Å). Since they have larger dimensions they induce compressive stresses at the surface of the glass, which can thus provide more resistance. The duration of immersion determines the finally obtained stress level. The stress distribution does not take the same form as in the case of thermally hardened glass and results in considerably stronger glass than if unhardened glass were to be hardened in thermal manner. It is noted in this respect that chemically hardened glass generally has a much higher compressive stress at the surface of the glass sheet which decreases relatively quickly just beneath the surface, wherein there is a limited tensile stress in the centre (half depth) of the glass sheet, resulting in a block-shaped stress profile. Thermally hardened glass generally has a considerably lower compressive stress at the surface of the glass sheet, wherein a relatively high tensile stress is present in the centre of the glass sheet, resulting in a parabolic stress profile.

Intermediate layer 6 is manufactured in this exemplary embodiment from a copolymer consisting of 81% ethylene, 19% methacrylic acid, wherein 37% of the acid groups are neutralized with sodium or zinc. The Young's modulus of such an ionomer amounts to about 361 MPa.

A side of the second glass sheet 3 remote from intermediate layer 6 is provided with an adhesive layer 7 to enable adhesion of mirror 1 against another object. The adhesive layer can optionally take a light-transmitting form here, whereby it may be possible to look through mirror 1, this depending on the optional light transmission of metal layer 4. It is possible to envisage applying one or more alternative fastening elements instead of an adhesive layer 7.

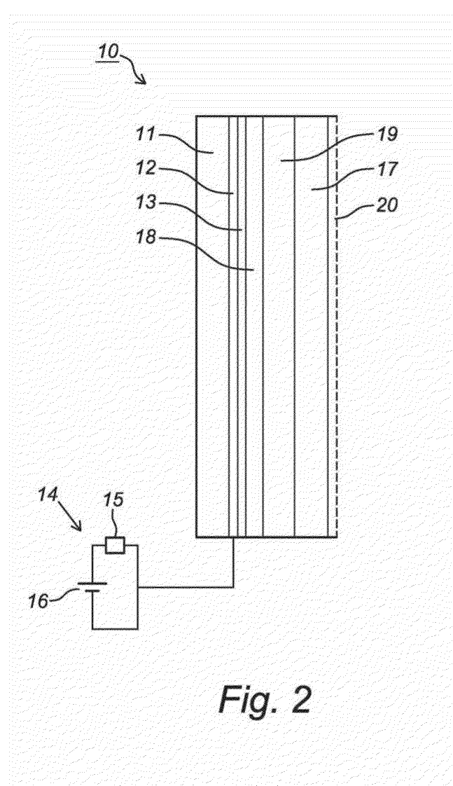

FIG. 2 shows a side view of an alternative mirror 10 according to the invention. Mirror 10 comprises a hardened, ultra-thin front glass sheet 11 which is thermally or chemically hardened. Arranged against a rear side of the front glass sheet 11 is an electrochromic layer 12 which can optionally be protected by means of a protective layer 13. Electrochromic layer 12 has the property that it changes colour when voltage is applied to electrochromic layer 12. The strength of the voltage generally determines the degree of change in colour. As also shown in FIG. 2, electrochromic layer 12 forms part of an electronic circuit 14 which also incorporates a control unit 15 and an energy source 16, such as a battery or connection to the mains electricity. Voltage can be applied to electrochromic layer 12 in controlled manner by means of the control unit. When no voltage is being applied to electrochromic layer 12, electrochromic layer 12 is substantially transparent. When voltage is being applied to electrochromic layer 12, it is possible to have electrochromic layer 12 take on a colour desired beforehand, for instance silver colour, whereby electrochromic layer 12 acquires reflective properties and mirror 10 can actually also be used as mirror. In order to impart greater strength and increased impact-resistance to mirror 10, mirror 10 also comprises a rear ultra-thin, hardened glass sheet 17 (or other type of strengthening structure) connected via a polymer fastening layer 18, for instance manufactured from EVA or PVB, to the front glass sheet, thus forming a reliable and strong laminate. It is also advantageous for fastening layer 18 to be formed by a (glass) fibre-reinforced polymer fastening layer, in particular a prepreg. Fastening layer 18 is preferably provided with one or more fire-retardant additives, such as one or more organohalogen compounds and/or one or more intumescent substances. An additional material layer 19 can optionally also be positioned between the rear glass sheet 17 and fastening layer 18 in order to impart additional functionality to mirror 10. This additional material layer 19 can for instance be formed by a coloured film layer, a decorative film layer and/or an electronic layer. An electronic layer is understood to mean a material layer able to visualize a video image (for users) or an interactive material layer, whereby the glass laminate can function as touchscreen. Physical contact between user and the glass laminate need not be necessary here in order to enable operation of the interactive material layer. Known interactive material layers are for instance resistive layers, capacitive layers, surface acoustic wave (SAW) layers, acoustic pulse recognition (APR) layers, infrared layers, near field imaging (NFI) layers. The above stated non-limitative examples will be known to a skilled person in the field of interactive material layers. An adhesive layer 20 can be applied to attach mirror 10 to an external bearing structure.

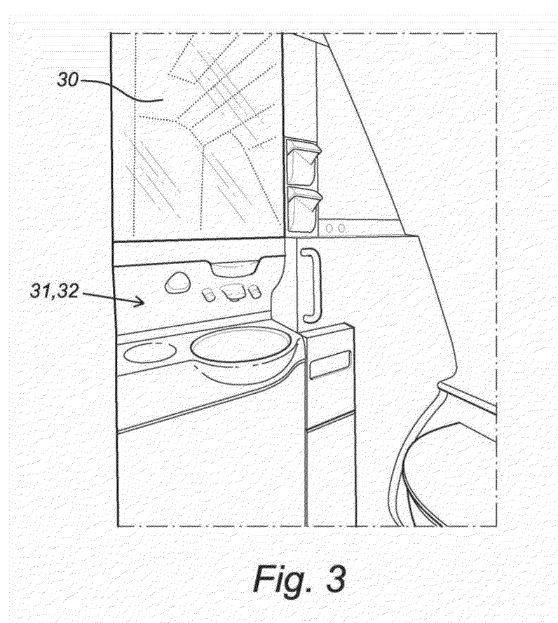

FIG. 3 shows a perspective view of the application of a mirror 30 according to the invention in a sanitary space 31 of a vehicle 32, such as an aircraft, boat or bus. In addition to being light in weight and having a relatively high impact resistance, additional advantages of the applied mirror according to the invention are the high degree of scratch-resistance and having a uniform thickness, whereby the light refraction is likewise relatively uniform, this enhancing the image reflection of mirror 30.

It will be apparent that the invention is not limited to the exemplary embodiments shown and described here, but that within the scope of the appended claims numerous variants are possible which will be self-evident to the skilled person in this field.

1. A mirror for a vehicle, in particular an aircraft, comprising:
at least one ultra-thin, hardened first glass sheet with a maximum thickness of 1.0 mm;
at least one fastening layer connected to a front side of the first glass sheet and comprising at least one polymer and at least one fire-retardant additive,
at least one hardened second glass sheet with a maximum thickness of 0.7 mm connected to the fastening layer, the second glass sheet positioned on a front side, remote from the first glass sheet, of the fastening layer connected to the first glass sheet, and
at least one mirror layer disposed between the first glass sheet and the second glass sheet.

2. The mirror as in claim 1, wherein the first glass sheet is chemically hardened.

3. The mirror as in claim 1, wherein the second glass sheet is chemically hardened.

4. The mirror as in claim 1, wherein at least one of the fire-retardant additives is formed by an organohalogen compound.

5. The mirror as in claim 1, wherein at least one of the fire-retardant additives is formed by an intumescent substance comprising melamine.

6. The mirror as in claim 1, wherein the fastening layer comprises at least one fibre-reinforced polymer.

7. The mirror as in claim 1, wherein the mirror layer is disposed between the first glass sheet and the fastening layer.

8. The mirror as in claim 1, wherein the mirror layer has a light transmission of between 10% and 80%.

9. The mirror as in claim 1, wherein a side of the mirror layer remote from the first glass sheet is at least partially provided with a coating which protects the mirror layer.

10. The mirror as in claim 1, wherein the fastening layer comprises a film.

11. The mirror as in claim 10, wherein the fastening layer further comprises an ionomer.

12. The mirror as in claim 1, wherein the fastening layer comprises at least one thermosetting polymer which is at least partially cured.

13. The mirror as in claim 12, wherein the thermosetting polymer is fibre-reinforced.

14. The mirror as in claim 1, wherein the fastening layer is substantially transparent.

15. The mirror as in claim 1, wherein the fastening layer has a maximum thickness of 2.5 mm.

16. The mirror as in claim 1, wherein the second glass sheet is directly connected to a front side, remote from the first glass sheet, of the fastening layer connected to the first glass sheet.

17. The mirror as in claim 1, wherein the second glass sheet is connected to the first glass sheet such that the fastening layer is enclosed by the second glass sheet and the first glass sheet.

18. The mirror as in claim 1, further comprising a laminate that comprises an adhesive layer for attaching the laminate to a bearing structure such as a wall.

19. The mirror as in claim 1, wherein the mirror comprises at least one additional material layer positioned on a front side of the fastening layer remote from the first glass sheet, wherein the at least one additional material layer is chosen from the group consisting of: a decorative layer, a coloured layer, an additional fastening layer, an electronic layer, a reflective layer and an additional glass sheet.

20. The mirror as in claim 1, wherein at least a part of an end surface of at least one glass sheet is polished.

21. A method for manufacturing a mirror for a vehicle, comprising:
providing at least one ultra-thin hardened first glass sheet with a maximum thickness of 1.0 mm,
arranging a mirror layer on at least one front side of the first glass sheet, successively laying onto each other the first glass sheet provided with the mirror layer, a fastening layer comprising at least one polymer, wherein the fastening layer comprises at least one fire-retardant additive, and a hardened second glass sheet with a maximum thickness of 0.7 mm, and
laminating, using heat, the first glass sheet provided with the mirror layer and the fastening layer to form a mirror.

22. The method as claimed in claim 21, wherein the fastening layer arranged during step comprises at least one thermosetting polymer, and further comprising curing the thermosetting polymer being at least partially and preferably substantially wholly cured during the laminating.
